(19) United States
(12) Patent Application Publication
(10) Pub. No.: US 2017/0295712 A1
(43) Pub. Date: Oct. 19, 2017

(54) HAND-HELD WEED EXTRACTOR AND CULTIVATOR

(71) Applicants: Robert C. LaViano, Saddle River, NJ (US); Steven LaViano, Mansfield, MA (US)

(72) Inventors: Robert C. LaViano, Saddle River, NJ (US); Steven LaViano, Mansfield, MA (US)

(21) Appl. No.: 15/395,520

(22) Filed: Dec. 30, 2016

Related U.S. Application Data
(60) Provisional application No. 62/322,763, filed on Apr. 14, 2016.

(51) Int. Cl. A01B 1/16; A01B 1/24

(52) U.S. Cl. CPC A01B 1/16; A01B 1/243

(57) ABSTRACT

A gardening apparatus is provided for which may be used for cultivating, as well as weed and other nuisance plant removal. The gardening apparatus includes a shaft having a first end and a second end, wherein the first end includes a recurved hook, and wherein the recurved hook includes two prongs separated by a distance configured to grip onto at least a portion of a weed. The gardening apparatus may further include a handle coupled to the second end of the shaft.

This utility patent application claims priority to U.S. Provisional Application No. 62/322,763, filed on Apr. 14, 2016. The contents of this application are hereby incorporated by reference.

### FIELD OF THE EMBODIMENTS

This invention relates to gardening tools and, in particular, to hand-held weed extractors and cultivators.

### BACKGROUND OF THE EMBODIMENTS

Many individuals enjoy gardening on their property. However, the growth of weeds can harm the health of the desired plants and can cause the garden to have an unpleasant look. Therefore, the removal of weeds is important to the growth of a healthy lawn and garden.

Weeds are difficult to isolate and remove from lawns and gardens without disturbing the desirable plants. Many weed removing tools can be difficult to use and can cause damage to the plants or foliage surrounding the weeds. Many of these devices rely of multiple steps to cut the roots of the weeds or loosen the soil around the weeds, and then removing the weeds by hand. This disturbs the surrounding plants, moves more soil out of place, and requires a great deal of time and effort. Therefore, a better method of removing weeds is needed.

Additionally, aerating a garden can further increase and prolong the health of the garden by allowing water, air, and various nutrients to penetrate the soil. Presently, there is no tool on the market that enables a user to both aerate the garden and remove the undesirable weeds.

Examples of related art are described below:

U.S. Pat. No. 4,319,642 provides for a hand tool for grooming outdoor terraces, comprising a weed hook and associated handle together with gauge structure limiting the depth to which the hook may penetrate. It is used primarily for removing grass, weeds or other debris from cracks or grooves in terraces or paved walks.

U.S. Pat. No. 4,819,736 provides for a tool for removing roots and plants from the earth while only minimally disturbing the surrounding area. The tool includes a first, proximal end for attachment to a device for rotating the tool and a second end including a three-tined head. One tine or prong of the three-tined head is longer than the remaining tines and serves to anchor and stabilize the tool in a working position while preventing a vibration or wandering of the tool during rotation. Adjacent prongs or blades rotate about the elongated prong as the body of the tool is rotated and thus disrupt the soil and root system of the undesired plant enabling the plant to be easily removed from the ground.

U.S. Pat. No. 5,360,071 provides for a gardening tool for digging around weeds, vegetables, bushes, etc., and in particular, a gardening tool having a handle, two laterally mounted straight prongs extending parallel to one another, and a medially mounted pair of diverging prongs which extend in a gradually diverging manner from one another to define a V-shaped member.

U.S. Pat. No. 7,100,899 provides for a weed puller for gathering weeds at the interstices between the weed foliage above the ground and the weed root below the ground and includes a handle for being held by a standing operator at one end and supporting a body at the bottom distal end. The body defines two blunted prongs on either side of a central axis on the body extending away from the attachment to the handle through the body. The two prongs define therebetween a V-shaped gathering gap with blunted opposed V-shaped edges on either side of the axis. There is a second body portion including portions of the two prongs, the first portion being divided from the second portion along a bending axis normal to the central axis of the body. The second body portion includes portions of the two prongs bent upwardly and away towards the handle at an obtuse angle along the bending axis to form a weed pulling cradle area in the body. When a weed is gathered between the V-shaped gathering gap between the weed foliage and the weed root, the weed is pulled at the weed root immediately underlying the weed foliage between the first body portion and the second body portion to center in the weed pulling cradle area when the handle is withdrawn from the ground towards the standing operator. Weed removal with the attached root and undisturbed seeds can result.

U.S. Patent Application No. 2003/0159841 provides for a combined home garden tool for easily and efficiently removing weeds, digging or leveling of soil, and planting which does not require repetitive kneeling or stooping. The invention includes a long or short handle attached to a unique head having a combined weed remover, pointed or flat trenching tool and soil leveler. The weed removal section includes a set of generally parallel elongated tines with pointed ends, the tines being spaced apart from each other to form as set of narrow V-shaped openings for engagement with weeds that accomplishes removal of the weeds and substantially all of their associated root systems without requiring repetitive kneeling or stooping.

U.S. Patent Application No. 2010/0200255 provides for a gardening tool including an elongate handle and a head portion. The head portion includes a receiving means for receiving an end of the handle. A curved blade member extends outwardly from the receiving means. A pronged portion also extends outwardly from the receiving means and generally oppositely to the blade member. The pronged portion has three prongs spaced apart and generally in parallel. Each prong has a bifurcated pointed tip for assisting in engaging soil and vegetation.

U.S. Patent Application No. 2012/0047869 provides for weeder rake systems which comprise a multifunctional gardening tool for both removing and clearing weeds and debris. A weeder rake generally comprises a long cylindrical handle comprising a rake head on one end and a weeder on the other end. The rake head comprises a fan-like profile comprising a plurality of raking tines for effectively collecting and clearing debris. The weeder a weed cutter head comprising a cutting blade which is attachable via a blade fastener. The weed cutter head and the cutting blade form a trapezoid-shaped member comprising and open inner volume. The cutting blade is preferably serrated and may be used for cutting and removing weeds and vegetation.

U.S. Patent Application No. 2013/0146319 provides for a multipurpose garden tool having an elongated handle and a head implement. The head comprises a braced handle portion securing the backside of an upstanding body portion, below which extends a plurality of offset rake tines. The implement is largely rectangular and includes a curved lower region. The upper portion forms an elongated leveling edge or a hula hoe device for scraping, leveling, cutting and distributing soil. The lower edge forms a rake tool having elongated tines for separated and lifting soil. The leftmost short edge forms a pointed blade for chopping, prying and furrowing soil. Finally, the rightmost short edge forms a square blade edge for shearing and chopping operations. The tines are offset from the upper body region to increase soil penetration and debris separation while raking. Finally, a plurality of holes may further be placed through the body region for use as a shearing tool.

None of the art described above addresses all of the issues that the present invention does. For example, none of the art described addresses a hand-held gardening apparatus that both removes weeds with ease and is capable of enabling a user to aerate the soil.

### SUMMARY OF THE EMBODIMENTS

A gardening apparatus is provided for. The gardening apparatus includes a shaft having a first end and a second end, wherein the first end includes a recurved hook, and wherein the recurved hook includes two prongs separated by a distance configured to grip onto at least a portion of a weed. The gardening apparatus further includes a handle coupled to the second end of the shaft.

It is an object of the present invention to provide for the gardening apparatus, wherein the recurved hook conforms to a radius of approximately 15 cm from a centerline of the shaft located approximately within the range of 2 to 15 cm from the handle.

It is an object of the present invention to provide for the gardening apparatus, wherein the distance between the prongs is approximately 5-14 mm.

It is an object of the present invention to provide for the gardening apparatus, further comprising a connector for attaching a handle extension to the second end of the shaft, wherein the connector includes a threaded portion for connecting the handle extension to the second end of the shaft.

It is an object of the present invention to provide for the gardening apparatus, wherein the shaft includes stainless steel.

It is an object of the present invention to provide for the gardening apparatus, wherein each of the prongs are configured to have a width configured to enable a user to penetrate the ground to aerate soil.

### BRIEF DESCRIPTION OF THE DRAWINGS

FIG. 1 shows a side view of a gardening apparatus, according to an embodiment of the present invention.

FIG. 2 shows a side view of a gardening apparatus, according to an embodiment of the present invention.

FIG. 3 shows a front view of a pair of prongs of the gardening apparatus, according to an embodiment of the present invention.

FIG. 4 shows a perspective view of a gardening apparatus according to an embodiment of the present invention.

### DESCRIPTION OF THE PREFERRED EMBODIMENTS

A system and method for removing weeds and aerating soil is described below, according to various embodiments of the present invention. According to an embodiment of the present invention, a gardening apparatus is described that enables a user to pluck weed from the ground in seconds, with little effort. The weeds include many plants that are difficult to remove without cutting the roots or digging out the plant and may include, e.g., crabgrass plants, clovers, plantain, and Creeping Charlie. Of course, the gardening apparatus may remove a wide variety of plant life with little effort.

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

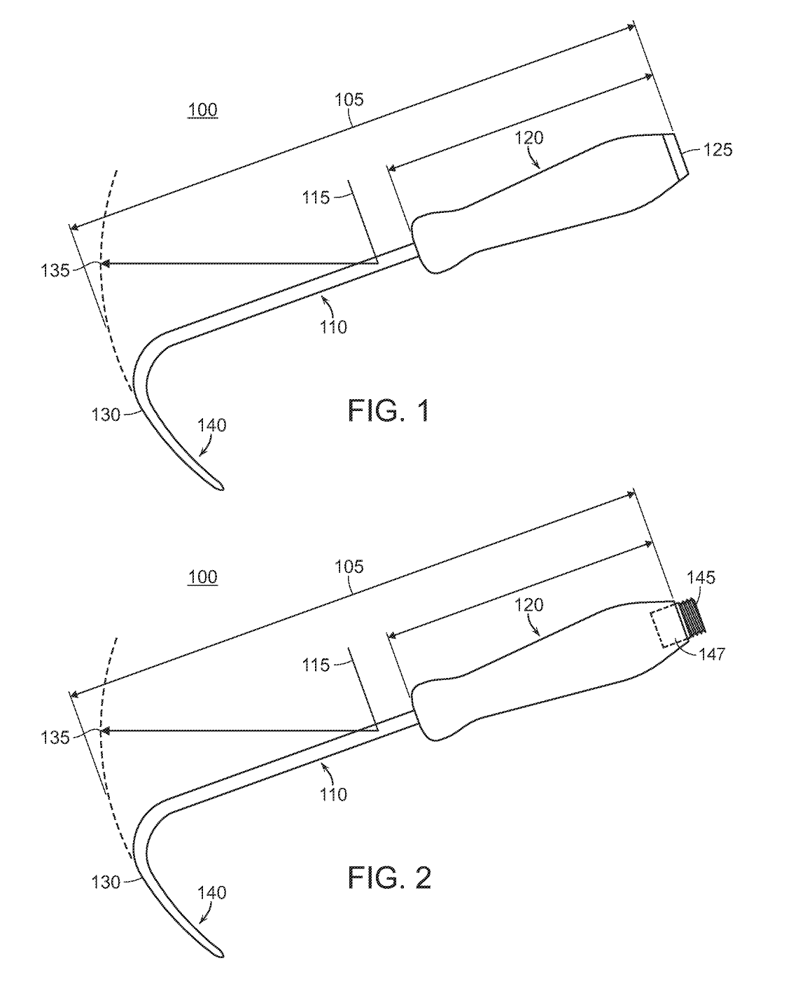

Referring now to FIG. 1, a side perspective view of a gardening apparatus 100 is illustratively depicted, in accordance with an embodiment of the present invention.

According to an embodiment of the present invention, the gardening apparatus 100 includes a shaft 110 having a first end and a second end, and a handle 120 with an end cap 125 coupled to the second end of the shaft 110. The first end of the shaft 110 includes a recurved hook 130 having two or more prongs 140.

According to an embodiment of the present invention, the shaft 110 is made of a material strong enough for the removal of plants. Additionally, the shaft is of a sufficient length and strength to enable ease of use through the handle 120. According to an embodiment, the shaft 110 includes stainless steel. Of course, other materials may be used, while maintaining the spirit of the present invention. According to an embodiment, the shaft 110 is solid and has a circumference that may be circular, oval, square, or any other suitable shape.

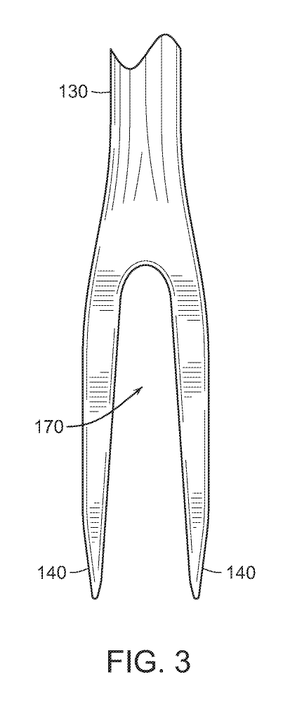

According to an embodiment, the shaft 110 is shaped such that the hook 130 and prongs 140 are aligned with the natural motion of the gardening apparatus 100 in the hand of a user in a way similar to a burrowing animal's claws as the claws dig through the soil. A user quickly inserts the prongs 140 into the soil, behind the center of the weed, such that the core of the weed's roots become wedged in a space 170 (shown in FIG. 3) between two of the prongs 140, enabling the gardening apparatus 100 to grip the weed. This can be done with the user standing, sitting, or kneeling. Once the stem is gripped by the gardening apparatus 100, the weed can be quickly be pulled out of the ground with minimal disturbance to the surrounding soil by pulling the gardening apparatus 100 out of the soil. In the event that plants, such as, e.g., clover and Creeping Charlie, have runners, the prongs 140 have the ability to slide under the runners to locate and remove the runners, as well as the main weed. The weed (and runners) can be removed from the gardening apparatus 100 by hitting the shaft 110 down against a receptacle, or by any other suitable means.

According to an embodiment, the second end of the shaft 110 is inserted through the entire length of the handle 120 for strength and capped off with an end cap 125. According to a particularly advantageous embodiment of the present invention, the handle 120 is ergonomically designed so that the gardening apparatus 100 is easy to hold and has a good feel in the hand of a user during use.

According to an embodiment, the claw 130 conforms to a radius 135 of approximately 15 cm from a centerline 115 of the shaft 110 located approximately in the range of 2 to 15 cm from the handle 120. According to an embodiment, the distance from the centerline 115 to the tip of the prongs 140 is approximately 90 mm. According to an embodiment, the overall length 105 of the gardening apparatus 100 is approximately 32 cm. It is noted, however, that other lengths may also be used, while maintaining the spirit of the present invention.

Referring now to FIG. 2, a side perspective view of gardening apparatus 100 is illustratively depicted, in accordance with an embodiment of the present invention.

According to the embodiment shown in FIG. 2, instead of an end cap 125, a handle connector 145 consisting of a male screw thread is attached to the handle 120 to enable a user to connect handle extension to the gardening apparatus 100 for two-handed use of the gardening apparatus 100. According to an embodiment of the present invention, the handle extension has a rigid shape. According to another embodiment of the present invention, the handle extension is retractable and/or able to be extended or be permanent. According to an alternative embodiment, instead of a male screw thread 147, a handle connector consisting of a female screw thread 147 is positioned within the handle for the insertion of a handle extension of the gardening apparatus 100.

Referring now to FIG. 3, a front perspective view of a pair of prongs 140 of the gardening apparatus 100 is illustratively depicted, in accordance with an embodiment of the present invention.

According to an embodiment of the present invention, one or both of the prongs 140 has a length of approximately 4 cm. According to an embodiment of the present invention, the space 170 between the prongs 140 widens from the fork to the tips of the prongs 140, with the space 170 between the prongs 140 ranging from approximately 5 mm (at the fork) to 14 mm (at the tip). It is noted, however, the other lengths and measurements may also be used, while maintaining the spirit of the present invention.

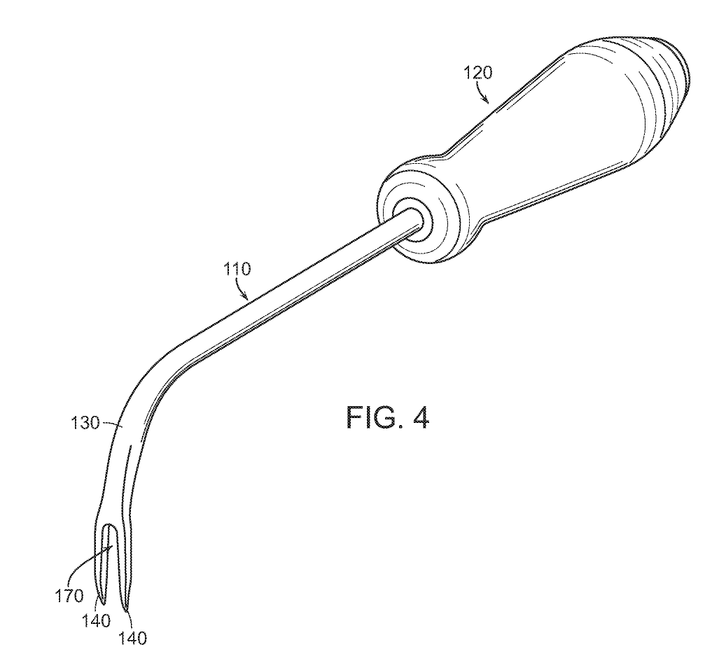

As shown in FIG. 4, there is a general perspective view of an embodiment of the present invention as described herein.

When weeding in a bed or garden, the gardening apparatus 100 may be used to remove small to large weeds and also as a cultivator to disturb very small weed seedlings and to cultivate flowers and vegetables by driving the prongs 140 deep into the soil next to the plant and move the gardening apparatus 100 towards the user, keeping the prongs 140 aligned with the direction of pull. The gardening apparatus 100 will remain under the soil until it is extracted, and it will loosen and aerate the soil down to approximately 10 cm for the distance than it is pulled. This will cause minimal disturbance of the surface of the soil or of any surface mulch, requiring very little redressing. The shape of the prongs 140 also make it easy for the user to aerate hard soil by puncturing the soil with the prongs 140.

It is noted that the present invention may be used for a variety of gardening uses. The dexterity of the gardening apparatus enables it to be used for planting seedlings, harvesting vegetables, preparing beds when laying stones and demolition work to pry up old boards, shingles, etc., and for recreational clamming.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A gardening apparatus, comprising:
a shaft having a first end and a second end,
wherein the first end includes a recurved hook, and
wherein the recurved hook includes two prongs separated by a distance configured to grip onto at least a portion of a weed; and
a handle coupled to the second end of the shaft.

2. The gardening apparatus as recited in claim 1, wherein the recurved hook conforms to a radius of approximately 15 cm from a centerline of the shaft located approximately within the range of 2 to 15 cm from the handle.

3. The gardening apparatus as recited in claim 2, wherein a distance from the centerline of the shaft to a tip of at least one of the prongs is approximately 90 mm.

4. The gardening apparatus as recited in claim 1, wherein the prongs are of approximately equal length and between 3 cm and 5 cm in length.

5. The gardening apparatus as recited in claim 1, wherein the distance between the prongs is approximately 5-14 mm.

6. The gardening apparatus as recited in claim 1, wherein a length of the gardening apparatus is at least 32 cm.

7. The gardening apparatus as recited in claim 1, further comprising a connector for attaching a handle extension to the second end of the shaft.

8. The gardening apparatus as recited in claim 7, wherein the connector includes a threaded portion for connecting the handle extension to the second end of the shaft.

9. The gardening apparatus as recited in claim 1, wherein the shaft includes stainless steel.

10. The gardening apparatus as recited in claim 9, wherein the shaft is solid.

11. The gardening apparatus as recited in claim 1, wherein the shaft has a circumference of a shape selected from the group consisting of: a circle; an oval; and a square.

12. The gardening apparatus as recited in claim 1, wherein the shaft extends through the entire length of the handle.

13. The gardening apparatus as recited in claim 1, wherein the handle includes an end cap.

14. The gardening apparatus as recited in claim 1, wherein each of the prongs are configured to have a width configured to enable a user to penetrate soil to aerate the soil.

15. The gardening apparatus as recited in claim 1, further comprising a handle extension.

16. The gardening apparatus as recited in claim 15, wherein the handle extension is retractable.
